(19) United States
(12) Patent Application Publication
(10) Pub. No.: US 2007/0061151 A1
(43) Pub. Date: Mar. 15, 2007

(54) Method and system for TTY routing assistance

(75) Inventors: Bruce A. Groskreutz, Grand Blanc, MI (US); Dwayne A. Crocker, Lake Orion, MI (US); William L. Ball, Grosse Pointe Farms, MI (US); Kevin R. Krause, Northville, MI (US); Christopher L. Oesterling, Troy, MI (US); Julianne Petschke, Shelby Township, MI (US); Christopher Kearney, Sterling Heights, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: General Motors Corporation.

(21) Appl. No.: 11/227,752

(22) Filed: Sep. 15, 2005

(51) Int. Cl. G10L 21/06

(52) U.S. Cl. 704/276

(57) ABSTRACT

A method for displaying routing instructions includes receiving routing instructions from a call center at a telematics unit via a wireless network, the received route comprising at least one voice instruction. The method further includes converting the at least one voice instruction to text, and displaying the routing instructions including the text using a display device. Additionally, a method for displaying routing instructions includes receiving a TTY communication at a telematics unit from a call center using a wireless network and determining at least one routing instruction contained within the TTY communication. The method further includes displaying the at least one routing instruction using a display device.

### FIELD OF THE INVENTION

The present invention generally relates to a text typewriter (“TTY”) of any type that enables a person whose is deaf, hard of hearing, and/or speech-impaired to telecommunicate with another by allowing the person to type messages back and forth instead of talking and listening. The present invention specifically relates to delivering point-of-interest (“POI”) directions or routing servers to TTY devices of any type.

### BACKGROUND OF THE INVENTION

Inclusion of wireless communication systems within mobile vehicles provides an opportunity to communicate between the vehicle and a central location. For example, an operator of such a vehicle may subscribe to an in-vehicle messaging service that enables the subscriber to pull desired information from the central location via a wireless connection.

Wireless communication can include cellular connections, as well as short-range wireless connections such as an 802.11 connection. In order to pull the desired information from the central location, the communication is typically either triggered by a direct user request, or automatically as a result of an occurrence of a trigger event. In addition to wireless communication capacity, many vehicles are also equipped with GPS equipment to determine a location of the vehicle, and location-based triggers for pulling the desired information from the central location.

Delivering POI directions or routing services to the vehicle is well known in the art. However, delivering POI directions or routing services to the vehicle based on current TTY standards is very difficult due to limitations of character displays on TTY devices (e.g., typically two lines) and limited memory capacity. Subscribers therefore need an alternate way to recall directions without calling back to a central location. Even if the directions can still be seen on the TTY device, having to pick up and reference them on a small screen while driving can be potentially dangerous and awkward. Another problem with TTY devices is that they cannot differentiate different types of text (e.g. general advisor communication vs. routing instructions).

The present invention overcomes these disadvantages and advances the state of the art TTY routing services.

### SUMMARY OF THE INVENTION

One aspect of the present invention provides a method for displaying routing instructions includes receiving a routing instructions from a call center at a telematics unit via a wireless network, the received route comprising at least one voice instruction. The method further includes converting the at least one voice instruction to text, and displaying the routing instructions including the text using a display device.

Another embodiment of the invention provides a method for displaying routing instructions that includes receiving a TTY communication at a telematics unit from a call center using a wireless network and determining at least one routing instruction contained within the TTY communication. The method further includes displaying the at least one routing instruction using a display device.

A third embodiment of the invention provides a computer usable medium including computer readable code for displaying routing instructions that includes computer readable code for receiving a TTY communication at a telematics unit from a call center using a wireless network and computer readable code for determining at least one routing instruction contained within the TTY communication. The medium further includes computer readable code for displaying the at least one routing instruction using a display device.

The aforementioned and other features and advantages of the invention will become further apparent from the following detailed description of the presently preferred embodiments, read in conjunction with the accompanying drawings. The detailed description and drawings are merely illustrative of the invention rather than limiting the scope of the invention being defined by the appended claims and equivalents thereof.

### BRIEF DESCRIPTION OF THE DRAWINGS

FIG. 1 illustrates an operating environment for a method for providing routing instructions, in accordance with one aspect of the invention; and

FIG. 2 illustrates a first embodiment of a method for providing routing instructions, in accordance with one aspect of the invention;

FIG. 3 illustrates another method for providing routing instructions, in accordance with one aspect of the invention;

FIG. 4 illustrates another method for providing routing instructions, in accordance with one aspect of the invention;

FIG. 5 illustrates another method for providing routing instructions, in accordance with one aspect of the invention;

FIG. 6 illustrates another method for providing routing instructions, in accordance with one aspect of the invention;

FIG. 7 illustrates another method for displaying routing instructions, in accordance with one aspect of the invention;

FIG. 8 illustrates another method for providing routing instructions, in accordance with one aspect of the invention;

FIG. 9 illustrates another method for displaying routing instructions, in accordance with one aspect of the invention; and

FIG. 10 illustrates a method for storing routing instructions, in accordance with one aspect of the invention.

### DETAILED DESCRIPTION OF THE PREFERRED EMBODIMENTS

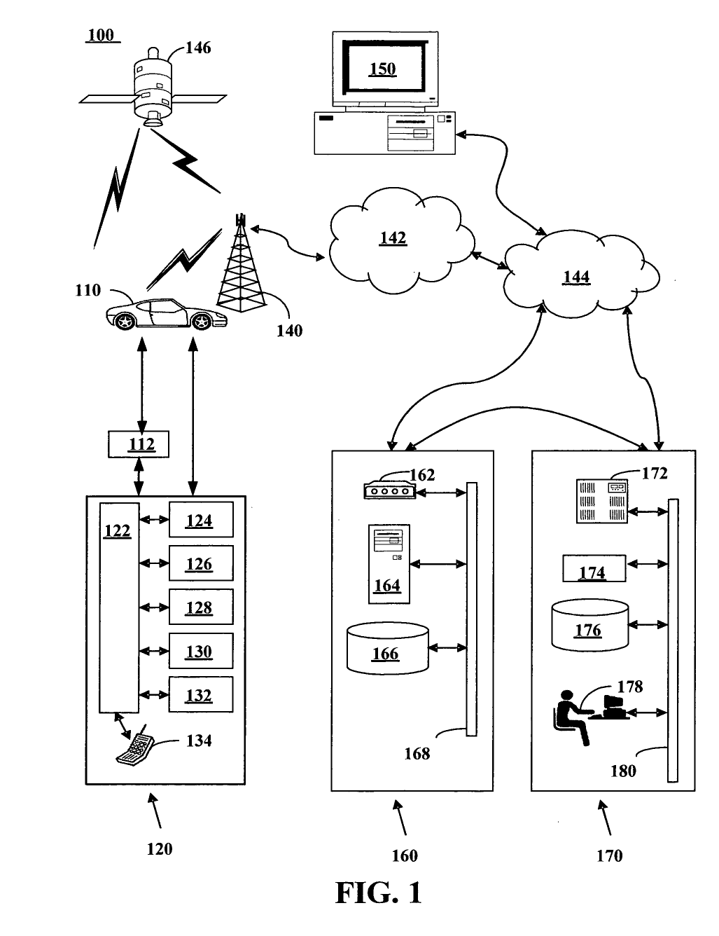

FIG. 1 illustrates an operating environment for a mobile vehicle communication system (“MVCS”) 100 for navigation. MVCS 100 includes a mobile vehicle communication unit (“MVCU”) 110, a vehicle communication network 112, a telematics unit 120, one or more wireless carrier systems 140, one or more communication networks 142, one or more land networks 144, one or more satellite broadcast systems 146, one or more client, personal or user computers 150, one or more web-hosting portals 160, and one or more call centers 170. In one embodiment, MVCU 110 is implemented as a mobile vehicle equipped with suitable hardware and software for transmitting and receiving voice and data communications. MVCS 100 may include additional components not relevant to the present discussion. Mobile vehicle communication systems and telematics units are known in the art.

MVCU 110 is also referred to as a mobile vehicle in the discussion below. In operation, MVCU 110 may be implemented as a motor vehicle, marine vehicle or as an aircraft. MVCU 110 may include additional components not relevant to the present discussion.

Vehicle communication network 112 sends signals to various units of equipment and systems within vehicle 110 to perform various functions such as monitoring the operational state of vehicle systems, collecting and storing data from the vehicle systems, providing instructions, data and programs to various vehicle systems, and calling from telematics unit 120. In facilitating interactions among the various communication and electronic modules, vehicle communication network 112 utilizes interfaces such as controller-area network (CAN), Media Oriented System Transport (MOST), Local Interconnect Network (LIN), Ethernet (10 base T, 100 base T), International Organization for Standardization (ISO) Standard 9141, ISO Standard 11898 for high-speed applications, ISO Standard 11519 for lower speed applications, and Society of Automotive Engineers (SAE) standard J1850 for higher and lower speed applications. In one embodiment, vehicle communication network 112 is a direct connection between connected devices.

Telematics unit 120 sends to and receives radio transmissions from wireless carrier system 140. Wireless carrier system 140 is implemented as any suitable system for transmitting a signal from MVCU 110 to communication network 142.

Telematics unit 120 includes a processor 122 connected to a wireless modem 124, a global positioning system (“GPS”) unit 126, an in-vehicle memory 128, a microphone 130, one or more speakers 132, and an embedded or in-vehicle mobile phone 134. In other embodiments, telematics unit 120 may be implemented without one or more of the above listed components such as, for example, speakers 132. Telematics unit 120 may include additional components not relevant to the present discussion. Telematics unit 120 is one example of a vehicle module.

In one embodiment, processor 122 is implemented as a microcontroller, controller, host processor, or vehicle communications processor. In one embodiment, processor 122 is a digital signal processor. In an example, processor 122 is implemented as an application specific integrated circuit. In another embodiment, processor 122 is implemented as a processor working in conjunction with a central processing unit performing the function of a general purpose processor. GPS unit 126 provides longitude and latitude coordinates of the vehicle responsive to a GPS broadcast signal received from one or more GPS satellite broadcast systems (not shown). In-vehicle mobile phone 134 is a cellular-type phone such as, for example, a digital, dual-mode (e.g., analog and digital), dual-band, multi-mode, or multi-band cellular phone.

Processor 122 executes various computer programs that control programming and operational modes of electronic and mechanical systems within MVCU 110. Processor 122 controls communication (e.g., call signals) between telematics unit 120, wireless carrier system 140, and call center 170. Additionally, processor 122 controls reception of communications from satellite broadcast system 146. In one embodiment, a voice-recognition application is installed in processor 122 that can translate human voice input through microphone 130 to digital signals. Processor 122 generates and accepts digital signals transmitted between telematics unit 120 and vehicle communication network 112 that is connected to various electronic modules in the vehicle. In one embodiment, these digital signals activate the programming mode and operation modes, as well as provide data transfers such as, for example, data over voice channel communication. In this embodiment, signals from processor 122 are translated into voice messages and sent out through speaker 132.

Wireless carrier system 140 is a wireless communications carrier or a mobile telephone system and transmits to and receives signals from one or more MVCU 110. Wireless carrier system 140 incorporates any type of telecommunications in which electromagnetic waves carry signal over part of or the entire communication path. In one embodiment, wireless carrier system 140 is implemented as any type of broadcast communication in addition to satellite broadcast system 146. In another embodiment, wireless carrier system 140 provides broadcast communication to satellite broadcast system 146 for download to MVCU 110. In an example, wireless carrier system 140 connects communication network 142 to land network 144 directly. In another example, wireless carrier system 140 connects communication network 142 to land network 144 indirectly via satellite broadcast system 146.

Satellite broadcast system 146 transmits radio signals to telematics unit 120 within MVCU 110. In one embodiment, satellite broadcast system 146 may broadcast over a spectrum in the “S” band of 2.3 GHz that has been allocated by the U.S. Federal Communications Commission for nationwide broadcasting of satellite-based Digital Audio Radio Service.

In operation, broadcast services provided by satellite broadcast system 146 are received by telematics unit 120 located within MVCU 110. In one embodiment, broadcast services include various formatted programs based on a package subscription obtained by the user and managed by telematics unit 120. In another embodiment, broadcast services include various formatted data packets based on a package subscription obtained by the user and managed by call center 170. In an example, processor 122 implements data packets received by telematics unit 120.

Communication network 142 includes services from one or more mobile telephone switching offices and wireless networks. Communication network 142 connects wireless carrier system 140 to land network 144. Communication network 142 is implemented as any suitable system or collection of systems for connecting wireless carrier system 140 to MVCU 110 and land network 144.

Land network 144 connects communication network 142 to client computer 150, web-hosting portal 160, and call center 170. In one embodiment, land network 144 is a public-switched telephone network. In another embodiment, land network 144 is implemented as an Internet Protocol (“IP”) network. In other embodiments, land network 144 is implemented as a wired network, an optical network, a fiber network, other wireless networks, or any combination thereof. Land network 144 is connected to one or more landline telephones. Communication network 142 and land network 144 connect wireless carrier system 140 to web-hosting portal 160 and call center 170.

Client, personal, or user computer 150 includes a computer usable medium to execute Internet browsers and Internet-access computer programs for sending and receiving data over land network 144 and, optionally, wired or wireless communication networks 142 to web-hosting portal 160 through a web-page interface using communication standards such as hypertext transport protocol, and transport-control protocol and Internet protocol. In one embodiment, the data include directives to change certain programming and operational modes of electronic and mechanical systems within MVCU 110.

In operation, a client utilizes computer 150 to initiate setting or re-setting of user preferences for MVCU 110. In an example, a client utilizes computer 150 to provide radio station presets as user preferences for MVCU 110. User-preference data from client-side software is transmitted to server-side software of web-hosting portal 160. In an example, user-preference data are stored at web-hosting portal 160.

Web-hosting portal 160 includes one or more data modems 162, one or more web-servers 164, one or more databases 166, and a network system 168. Web-hosting portal 160 is connected directly by wire to call center 170, or connected by phone lines to land network 144, which is connected to call center 170. In an example, web-hosting portal 160 connects to call center 170 utilizing an IP network. In this example, both components, web-hosting portal 160 and call center 170, are connected to land network 144 utilizing the IP network. In another example, web-hosting portal 160 is connected to land network 144 by one or more data modems 162. Land network 144 sends digital data to and receives digital data from modem 162, data that are then transferred to web server 164. Modem 162 may reside inside web server 164. Land network 144 transmits data communications between web-hosting portal 160 and call center 170.

Web server 164 receives user-preference data from user computer 150 via land network 144. In alternative embodiments, computer 150 includes a wireless modem to send data to web server 164 hosting portal 160 through a wireless communication network 142 and a land network 144. Data are received by land network 144 and sent to one or more web servers 164. In one embodiment, web server 164 is implemented as any suitable hardware and software capable of providing web server 164 services to help change and transmit personal preference settings from a client at computer 150 to telematics unit 120. Web server 164 sends to or receives from one or more databases 166 data transmissions via network system 168. Web server 164 includes computer applications and files for managing and storing personalized settings supplied by the client, such as door lock/unlock behavior, radio station preset selections, climate controls, custom button configurations, and theft alarm settings. For each client, the web server 164 potentially stores hundreds of preferences for wireless vehicle communication, networking, maintenance and diagnostic services for a mobile vehicle. In another embodiment, web server 164 further includes data for managing turn-by-turn navigational instructions.

In one embodiment, one or more web servers 164 are networked via network system 168 to distribute user-preference data among its network components such as databases 166. In an example, database 166 is a part of or a separate computer from web server 164. Web server 164 sends data transmission with user preferences to call center 170 through land network 144.

Call center 170 is a location where many calls are received and serviced at the same time, or where many calls are sent at the same time. In one embodiment, the call center is a telematics call center facilitating communications to and from telematics unit 120. In another embodiment, the call center is a voice call center, providing verbal communications between an advisor in the call center and a subscriber in a mobile vehicle. In yet another embodiment, the call center contains each of these functions. In other embodiments, call center 170 and web server 164 and hosting portal 160 are located in the same or different facilities.

Call center 170 contains one or more voice and data switches 172, one or more communication services managers 174, one or more communication services databases 176, one or more communication services advisors 178, and one or more network systems 180.

Switch 172 of call center 170 connects to land network 144. Switch 172 transmits voice or data transmissions from call center 170, and receives voice or data transmissions from telematics unit 120 in MVCU 110 through wireless carrier system 140, communication network 142, and land network 144. Switch 172 receives data transmissions from and sends data transmissions to one or more web server 164 and hosting portals 160. Switch 172 receives data transmissions from or sends data transmissions to one or more communication services managers 174 via one or more network systems 180.

Communication services manager 174 is any suitable hardware and software capable of providing requested communication services to telematics unit 120 in MVCU 110. Communication services manager 174 sends to or receives from one or more communication services databases 176 data transmission via network system 180. For example, communication services manager 174 may include at least one digital and/or analog modem.

Communication services manager 174 sends to or receives from one or more communication services advisors 178 data transmission via network system 180. Communication services database 176 sends or receives from communication services advisor 178 data transmissions via network system 180. Communication services advisor 178 receives from or sends to switch 172 voice or data transmissions. Communication services manager 174 provides one or more of a variety of services including initiating data over voice channel wireless communication, enrollment services, navigation assistance, directory assistance, roadside assistance, business or residential assistance, information services assistance, emergency assistance, and communications assistance.

Communication services manager 174 receives service-preference requests for a variety of services from the client computer 150, web server 164, hosting portal 160, and land network 144. Communication services manager 174 transmits user-preference and other data such as, for example, primary diagnostic script to telematics unit 120 through wireless carrier system 140, communication network 142, land network 144, voice and data switch 172, and network system 180. Communication services manager 174 stores or retrieves data and information from communication services database 176. Communication services manager 174 may provide requested information to communication services advisor 178. In one embodiment, communication services advisor 178 is implemented as a real advisor. In an example, a real advisor is a human being in verbal communication with a user or subscriber (e.g., a client) in MVCU 110 via telematics unit 120. In another embodiment, communication services advisor 178 is implemented as a virtual advisor. In an example, a virtual advisor is implemented as a synthesized voice interface responding to requests from telematics unit 120 in MVCU 110.

Communication services advisor 178 provides services to telematics unit 120 in MVCU 110. Services provided by communication services advisor 178 include enrollment services, navigation assistance, real-time traffic advisories, directory assistance, roadside assistance, business or residential assistance, information services assistance, emergency assistance, automated vehicle diagnostic function, and communications assistance. Communication services advisor 178 communicates with telematics unit 120 in MVCU 110 through wireless carrier system 140, communication network 142, and land network 144 using voice transmissions, or through communication services manager 174 and switch 172 using data transmissions. Switch 172 selects between voice transmissions and data transmissions.

In operation, an incoming call is routed to a telematics unit 120 within mobile vehicle 110 from call center 170. In one embodiment, the call is routed to telematics unit 120 from call center 170 via land network 144, communication network 142, and wireless carrier system 140. In another embodiment, an outbound communication is routed to telematics unit 120 from call center 170 via land network 144, communication network 142, wireless carrier system 140, and satellite broadcast system 146. In this embodiment, an inbound communication is routed to call center 170 from telematics unit 120 via wireless carrier system 140, communication network 142, and land network 144.

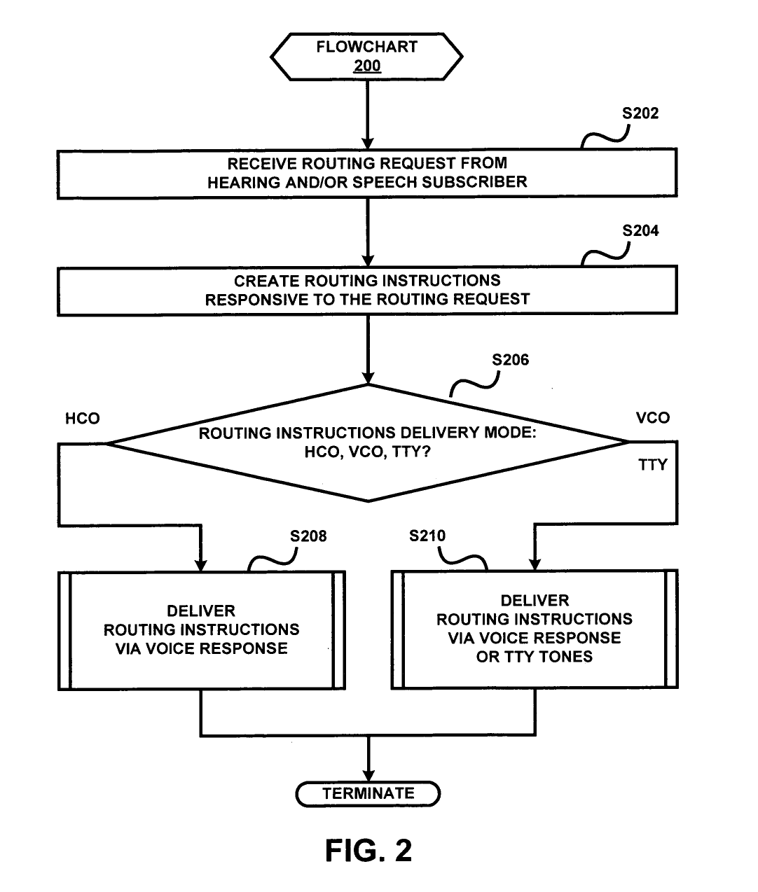

FIG. 2 illustrates a flowchart 200 representative of a TTY routing assistance method of the present invention as implemented by an advisor stationed at a call center (e.g., advisor 178 stationed at call center 170 as shown in FIG. 1). A stage S202 of flowchart 200 encompasses the advisor receiving a routing request from a hearing and/or speech impaired subscriber via a telematics unit (e.g., telematics unit 120 shown in FIG. 1), and a stage S204 of flowchart 200 encompasses the advisor creating routing instructions that comply with the routing request. Those having ordinary skill in the art will appreciate the various forms of the routing request including, but not limited to, a point-of-interest based routing request, an address based routing request and a telephone number based routing request.

A stage S206 of flowchart 200 encompasses the advisor selecting a routing instructions delivery mode for delivering the routing instructions to the hearing and/or speech impaired subscriber via the telematics unit. In one embodiment, the selection of the routing instructions delivery mode by the advisor is based on the routing request delivery mode used by the hearing and/or speech impaired subscriber to deliver the routing request to the advisor.

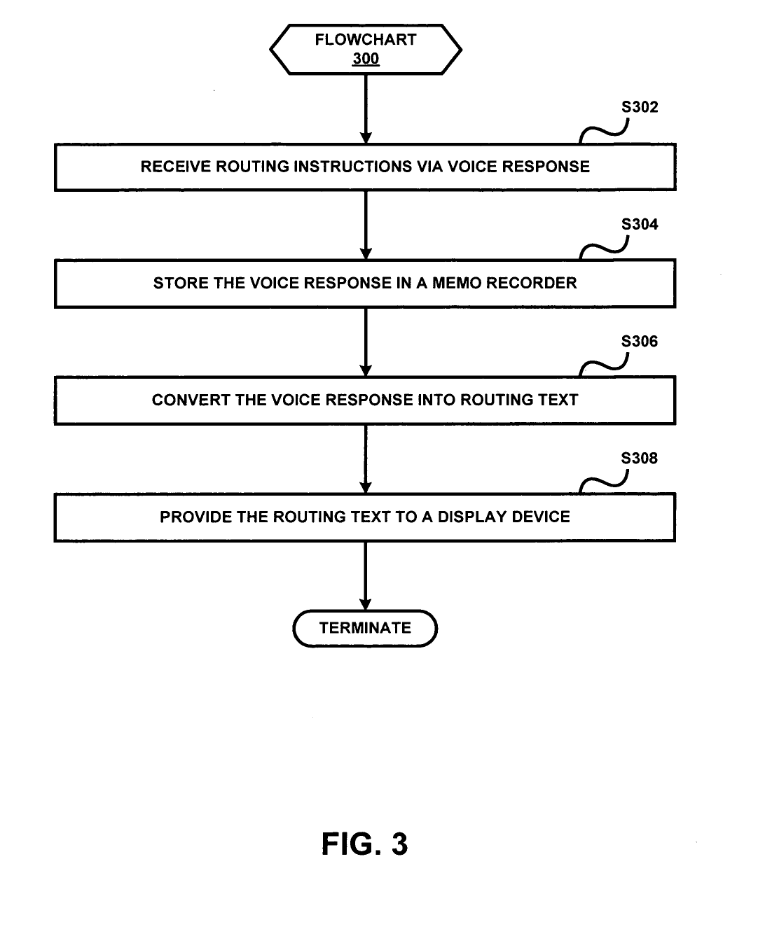

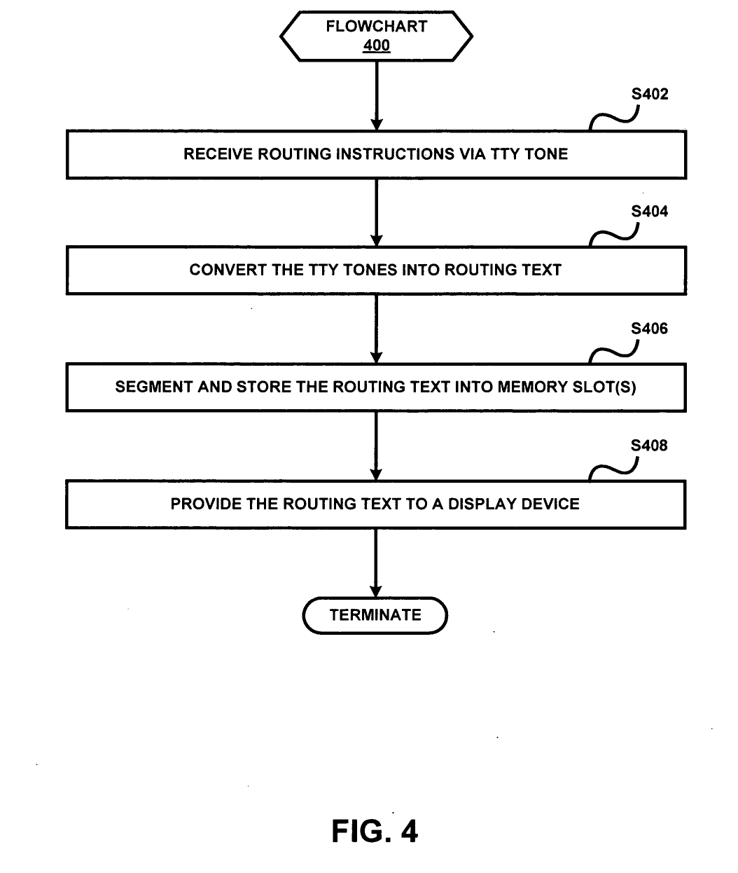

If the selected routing instructions delivery mode is a Hearing Carry-Over (“HCO”) mode, then the advisor proceeds to a stage S208 of flowchart 200 to deliver the routing instructions in the form of a voice response to the telematics unit whereby the telematics unit delivers the routing instructions to an associated TTY module as would be appreciated by those having ordinary skill in the art. If the selected routing instructions delivery mode is a Voice Carry-Over (“VCO”) mode or a TTY mode, then the advisor proceeds to a stage S210 of flowchart 200 to deliver the routing instructions in the form of a voice response to the telematics unit whereby the telematics unit will implement a voice response based VCO/TTY display method of the present invention represented by a flowchart 300 illustrated in FIG. 3, or to deliver the routing instructions in the form of TTY tones to the telematics unit whereby the telematics unit will implement a flowchart 400 representative of a TTY tone based VCO/TTY display method of the present invention represented by a flowchart 400 illustrated in FIG. 4.

Referring to FIG. 3, a stage S302 of flowchart 300 encompasses the telematics unit receiving the voice response from the advisor. A stage S304 of flowchart 300 encompasses the telematics unit storing the voice response in a memo recorder of the telematics unit. A stage S306 of flowchart 300 encompasses the telematics unit converting the stored voice response into a routing text. A stage S308 of flowchart 300 encompasses the telematics unit providing the routing text to a display device appropriate for subscriber's impairment, such as, for example, a heads up display, a driver information center or a radio, whereby the hearing and/or speech impaired subscriber can read the routing instructions. Those having ordinary skill in the art will appreciate the advantages of this voice response based VCO/TTY display method of the present invention including, but not limited to, allowing the hearing and/or speech impaired to recall/scroll through the routing instructions via steering wheel radio controls without having to take their eyes off the road for a significant period of time and without having to manipulate a handheld TTY module.

Referring to FIG. 4, a stage S402 of flowchart 400 encompasses the telematics unit receiving the TTY tones from the advisor. A stage S404 of flowchart 400 encompasses the telematics unit converting the TTY tones to a routing text. A stage S406 of flowchart 400 encompasses telematics unit 120 segmenting and storing the routing text in one or more memory slots. A stage S408 of flowchart 400 encompasses telematics unit 120 providing the routing text to a display device appropriate for subscriber's impairment such as, for example, a heads up display, a driver information center or a radio, whereby the hearing and/or speech impaired subscriber can read the routing instructions. Those having ordinary skill in the art will appreciate the advantages of this voice response based VCO/TTY display method of the present invention including, but not limited to, allowing the hearing and/or speech impaired to recall/scroll through the routing instructions via steering wheel radio controls without having to take their eyes off the road for a significant period of time and without having to manipulate a handheld TTY module.

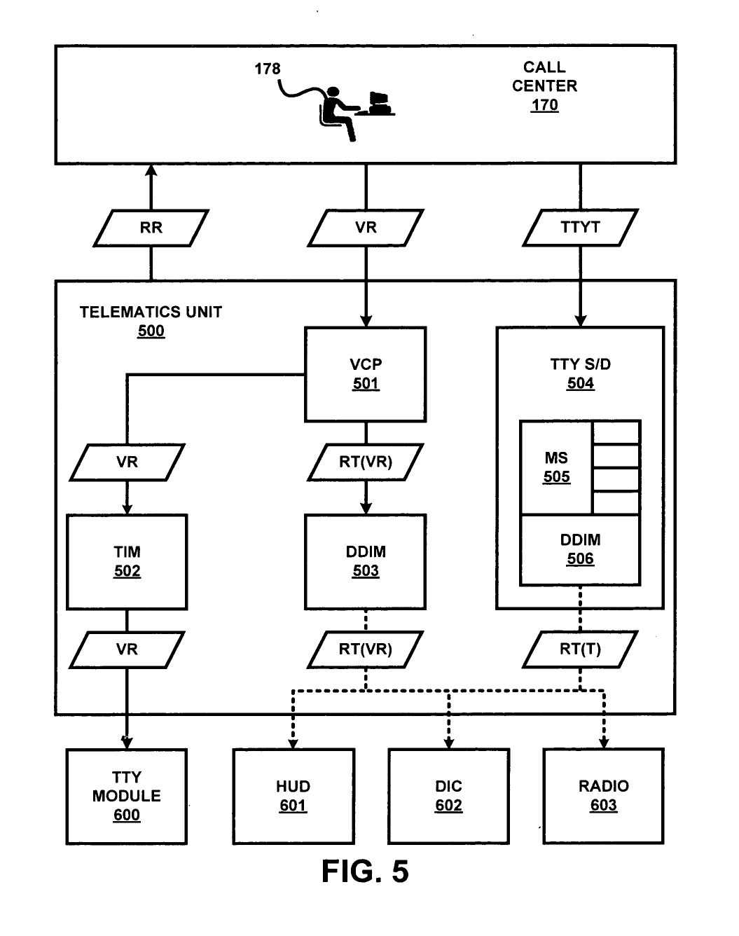

In practice, the present invention does not impose any limitations or any restrictions to a structural configuration of the telematics unit in implementing the various methods of the present invention. Thus, the following description of one embodiment of a telematics unit as shown in FIG. 5 for implementing flowcharts 300 and 400 does not limit nor restrict the scope of structural configurations of telematics unit for implementing the various methods of the present invention.

Referring to FIG. 5, a telematics unit 500 employs a VCP 501, a TTY interface module (“TIM”) 502, a display device interface module (“DDIM”) 503, and a TTYP scanner/decoder (“TSD”) 504 having a plurality of memory slots (“MS”) 505 and display device interface module (“DDIM”) 506. In operation, an advisor 178 of call center 170 as previously described in connection with FIG. 1 receives a routing request RR from a hearing and/or speech impaired subscriber via telematics unit 500 and creates routing instructions responsive to the routing request RR. With a HCO routing delivery mode, advisor 178 delivers the routing instructions in the form of a voice response VR to VCP 501 whereby VCP 501 processes voice response VR as needed to thereby provide the voice response VR to a TTY module 600 via TTY interface module 502.

With a VCO routing delivery mode or a TTY routing deliver mode, advisor 178 either delivers the routing instruction in the form of voice response VR to VCP 501 or delivers the routing instructions in the form of TTY tones TTYT to TTY scanner/decoder 504. In accordance with flowchart 300 when the routing instructions are in the form of voice response VR, VCP 501 converts voice response VR to routing text RT(VR) whereby the routing text RT(VR) is provided via display device interface module 502 to either a head up display (“HUD”) 601, a driver information center (“DIC”) 602 or a radio 603. In accordance with flowchart 400 when the routing instructions are in the form of TTY tones TTYT, TTY scanner/decoder 504 converts the TTY tones TTYT into routing text RT(T), segments and stores routing text RT(T) into memory slots 504 whereby segments of routing text RT(T) can be individually provided to via display device interface module 506 to either a head up display 601, a driver information center 602 or a radio 603.

In one embodiment, TTY scanner/decoder 504 examines all incoming audio signals in any signals from being sent back to the hearing and/or speech impaired subscriber from advisor 178 whereby TTY scanner/decoder 504 is capable of recognizing specific commands sent or their respective audio signal equivalents and routing the necessary text to the memory buffers of an appropriate display devices 601-603 in dependent on the command(s). The subscriber could then access the memory buffer at any given time to scroll through the directions using various controls in the vehicle. Each buffer/memory slot can be limited in size and, once full, any new data would overwrite the oldest data saved.

For example, TTY scanner/decoder 504 can receive a driving directions start command (e.g. **Route Start**) from advisor 178 by decoding TTY tones TTYT whereby TTY scanner/decoder 504 recognizes the lines to follow will be for a driving route. Thus, TTY scanner/decoder 504 opens up a memory slot 505 for the text (e.g. preset 1) and then displays the text on a pre-defined display device among device 601-603. This is in contrast to displaying all incoming TTY data on pre-defined display device. TTY scanner/decoder 504 will repeat the memory/display cycle for each line until such time TTY scanner/decoder 504 decodes a driving directions stop command (e.g. **Route End**) and switches back to normal mode until another recognizable driving directions start command is sent by advisor 178. The subscriber now has the ability to scroll through the route using radio/steering wheel commands and access other routes using preset buttons on the radio.

Additionally, TTY scanner/decoder 504 could be used to scan and decode audios signal for other commands the could be used for various vehicle settings, related or unrelated, to the TTY process, such as, for example, a command to trigger a particular hardware state or a command to trigger a particular component in the vehicle to act in a particular manner.

Those having ordinary skill in the art will appreciate the numerous and varied advantages and benefits of the present invention from the description herein of FIGS. 2-5.

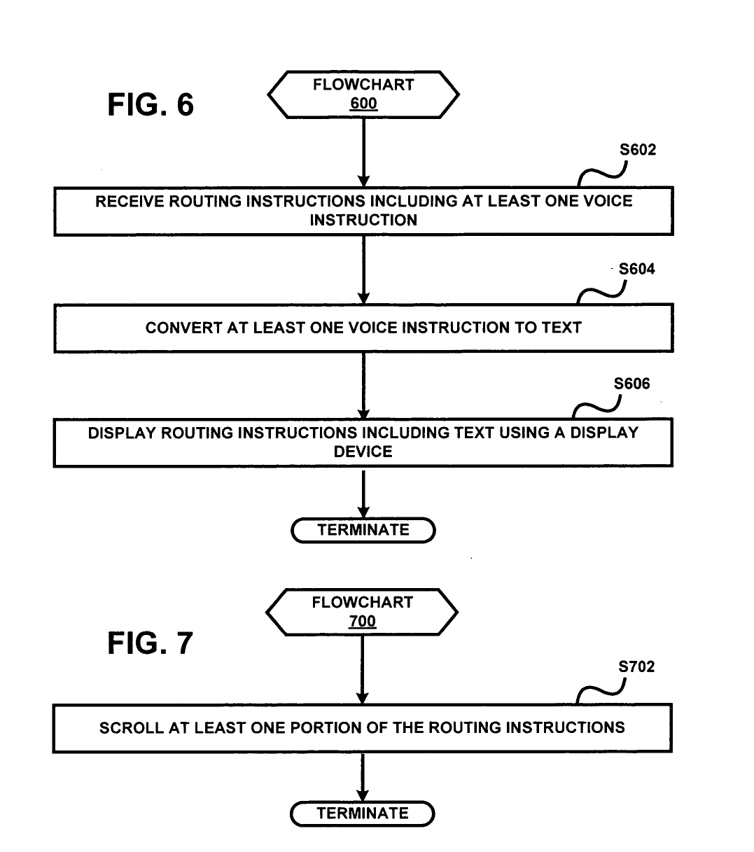

FIG. 6 illustrates one embodiment of a method 600 for displaying routing instructions, in accordance with one aspect of the invention. Method 600 begins by receiving routing instructions including at least one voice instruction at stage S602. In one embodiment, S602 is implemented as in S302. The routing instructions are received from a call center at a telematics unit via a wireless network.

After receiving the routing instructions, the at least one voice instruction is converted to text at stage S604. In one embodiment, S604 is implemented as in S306. The routing instructions, including the text, are displayed on a display device at step S606. The display device can be any device configured to provide information, such as a visual display, a driver information center and a heads-up display.

FIG. 7 illustrates one embodiment of a method 700 for displaying routing instructions in accordance with one aspect of the invention. Method 700 begins at S702 by scrolling at least one portion of the routing instructions in response to a command received from a device in communication with the telematics unit. As used herein, ‘scrolling’ means changing a displayed portion of information by moving forward or backward in a sequential list of information, such as moving forward or backward through a list of routing instructions. The device in communication with the telematics unit is any device configured to issue a command to scroll forward or backward through a list of routing instructions. For example, the device in communication with the telematics unit can be a radio command unit or a steering wheel command unit. For example, the device in communication with the telematics unit includes a right and left scroll command button, or an up and down scroll command button. Alternatively, the device in communication with the telematics unit can include a trackball, touchpad, joystick, jogwheel or other similar devices configured to provide instructions to navigate a user through a list of instructions. The device can be mounted on a dashboard, steering wheel, or any other location designed to be within reach of at least one person riding within a vehicle. The device in communication with the telematics unit can also be configured to respond to voice commands from a person within the vehicle. A radio command unit is any device configured to operate a radio. A steering wheel command unit is any device configured to be mounted upon a steering wheel and command at least one device located remote from the steering wheel.

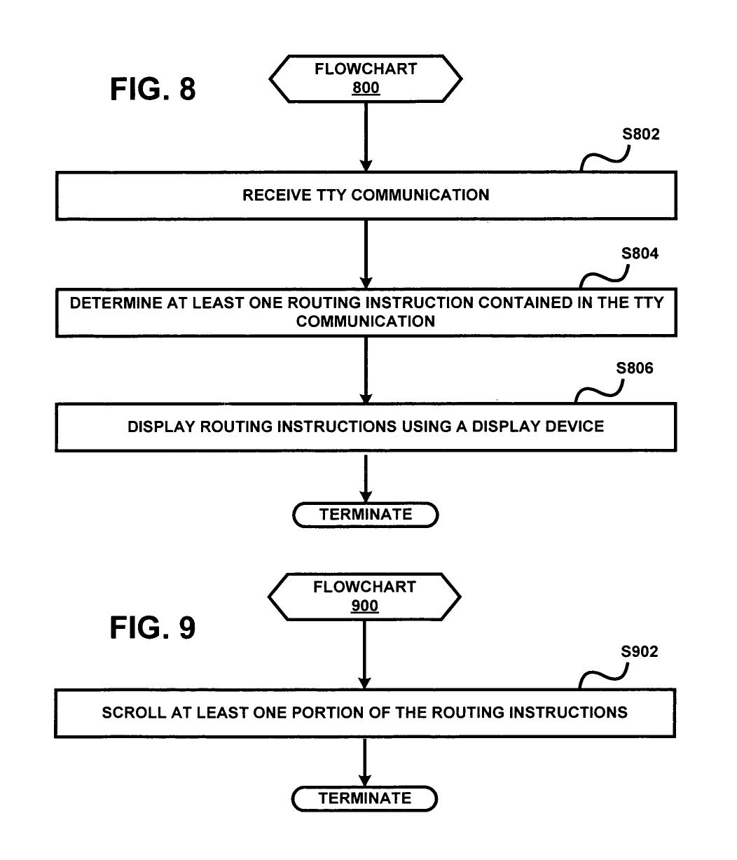

FIG. 8 illustrates another embodiment of a method 800 to display routing instructions in accordance with an aspect of the invention. Method 800 begins by receiving a TTY communication at stage S802. For example, S802 is implemented as in stage S402 in one embodiment. At least one routing instruction contained in the TTY communication is determined at S804. For example, S804 is implemented as in stage S404 in one embodiment. The determined routing instructions are displayed on a display device at S806. In one embodiment, S806 is implemented as in stage S408.

FIG. 9 illustrates one embodiment of a method 900 for displaying routing instructions in accordance with one aspect of the invention. Method 900 begins at S902 by scrolling at least one portion of the routing instructions in response to a command received from a device in communication with the telematics unit. As used herein, ‘scrolling’ means changing a displayed portion of information by moving forward or backward in a sequential list of information, such as moving forward or backward through a list of routing instructions. The device in communication with the telematics unit is any device configured to issue a command to scroll forward or backward through a list of routing instructions. For example, the device in communication with the telematics unit can be a radio command unit or a steering wheel command unit. For example, the device in communication with the telematics unit includes a right and left scroll command button, or an up and down scroll command button. Alternatively, the device in communication with the telematics unit can include a trackball, touchpad, joystick, jogwheel or other similar devices configured to provide instructions to navigate a user through a list of instructions. The device can be mounted on a dashboard, steering wheel, or any other location designed to be within reach of at least one person riding within a vehicle. The device in communication with the telematics unit can also be configured to respond to voice commands from a person within the vehicle. A radio command unit is any device configured to operate a radio. A steering wheel command unit is any device configured to be mounted upon a steering wheel and command at least one device located remote from the steering wheel.

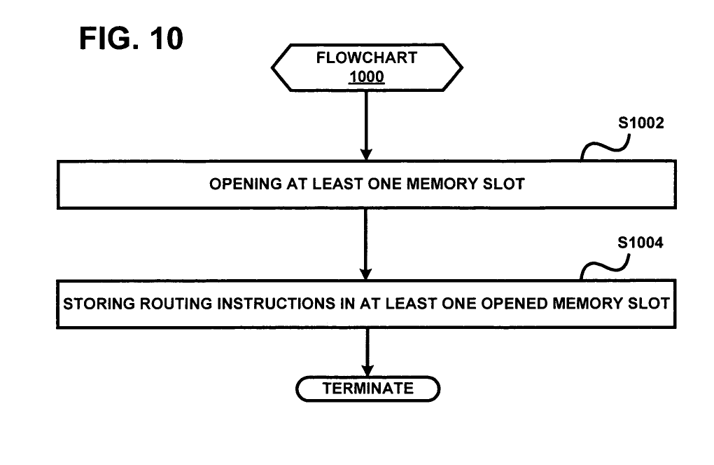

FIG. 10 illustrates one embodiment of a method 1000 of storing routing instruction in accordance with one aspect of the invention. Method 1000 begins by opening at least one memory slot at stage S1002. Routing instructions are stored in at least one opened memory slot at stage S1004. For example, S1002 and S1004 are implemented as in S406 in one embodiment.

The present invention may be embodied in other specific forms without departing from the spirit or essential characteristics. The described embodiments are to be considered in all respects only as illustrative and not restrictive.

What is claimed is:

1. A method for displaying routing instructions, the method comprising:
receiving a routing instructions from a call center at a telematics unit via a wireless network, the received route comprising at least one voice instruction:
converting the at least one voice instruction to text; and
displaying the routing instructions including the text using a display device.

2. The method of claim 1 wherein the display device is selected from the group consisting of a visual display, a driver information center and a heads-up display.

3. The method of claim 1 further comprising:
scrolling at least one portion of the routing instructions in response to a command received from a device in communication with the telematics unit.

4. The method of claim 3 wherein the device comprises at least one of the group consisting of a radio command unit, and a steering wheel command unit.

5. A method for displaying routing instructions, the method comprising:
receiving a TTY communication at a telematics unit from a call center using a wireless network;
determining at least one routing instruction contained within the TTY communication; and
displaying the at least one routing instruction using a display device.

6. The method of claim 5 wherein the display device is selected from the group consisting of a visual display, a driver information center and a heads-up display.

7. The method of claim 5 further comprising:
scrolling at least one routing instruction in response to a command received from a device in communication with the telematics unit.

8. The method of claim 7 wherein the device comprises at least one of the group consisting of a radio command unit, and a steering wheel command unit.

9. The method of claim 5 further comprising:
opening at least one memory slot based on determining at least one routing instruction contained within the TTY communication;
storing the at least one routing instruction in the opened memory slot.

10. The method of claim 5 wherein the telematics unit includes means for storing at least one routing instruction in memory in communication with the telematics unit.

11. A computer usable medium for displaying routing instructions, the computer usable medium comprising:
computer readable code for receiving a TTY communication at a telematics unit from a call center using a wireless network;
computer readable code for determining at least one routing instruction contained within the TTY communication; and
computer readable code for displaying the at least one routing instruction using a display device.

12. The medium of claim 11 wherein the display device is selected from the group consisting of a visual display, a driver information center and a heads-up display.

13. The medium of claim 11 further comprising:
computer readable code for scrolling at least one routing instruction in response to a command received from a device in communication with the telematics unit.

14. The medium of claim 13 wherein the device comprises at least one of the group consisting of a radio command unit, and a steering wheel command unit.

15. The medium of claim 11 further comprising:
computer readable code for opening at least one memory slot based on at least one routing instruction contained within the TTY communication;
computer readable code for storing the at least one routing instruction in the opened memory slot.
